(19) United States
(12) Patent Application Publication
(10) Pub. No.: US 2013/0153805 A1
(43) Pub. Date: Jun. 20, 2013

(54) FLUID FLOW CONTROL VALVE WITH FLOW METERING

(71) Applicants: Peter J. Stulik, Newport Beach, CA (US); Brent A. Stulik, Newport Beach, CA (US)

(72) Inventors: Peter J. Stulik, Newport Beach, CA (US); Brent A. Stulik, Newport Beach, CA (US)

(21) Appl. No.: 13/326,076

(22) Filed: Dec. 14, 2011

(51) Int. Cl. F16K 5/06

(52) U.S. Cl. 251/315.16; 251/304; 251/315.01

(57) ABSTRACT

An exemplary embodiment of a flow control valve having a secondary flow metering feature includes a rotating component which provides a primary flow control function. The rotating component rotates about an axis, and can be used to open or close the valve, typically with a 90 degree rotation of the rotating component by a handle or actuator. The valve includes a secondary flow metering function, by selectively varying the cross-sectional flow passage area through the rotating component. The rotating element may be a spherical ball, a non-spherical ball, or other component configuration which rotates about an axis, such as a conical configuration.

### BACKGROUND

Valves are used in many applications and can take many forms. Exemplary applications include water systems, fluid flow controls in chemical and pharmaceutical facilities. One well known type of valve is the ball valve in which a ball element with a center passage can be rotated by a handle between full open and full closed positions. Ball valves typically provide unsatisfactory metering capabilities in controlling the fluid flow, apart from full-on and full-off states.

### BRIEF DESCRIPTION OF THE DRAWINGS

Features and advantages of the disclosure will readily be appreciated by persons skilled in the art from the following detailed description when read in conjunction with the drawing wherein:

FIG. 1A is an isometric view of an exemplary embodiment of a ball valve with flow metering functions. FIG. 1B is a cross-sectional view taken along line 1B-1B of FIG. 1A. FIG. 1C is a cross-sectional view taken along 1C-1C of FIG. 1A.

FIG. 2 is an isometric view of an exemplary embodiment of a valve body structure for a ball valve as in FIG. 1A.

FIGS. 3A-3C are respective isometric, front and top views of an exemplary embodiment of a ball element for a ball valve as in FIG. 1A.

FIG. 4A is an isometric view of an exemplary embodiment of a transverse sliding member for a ball valve as in FIG. 1A. FIG. 1B is an end view of the transverse sliding member of FIG. 4A. FIG. 4C is a cross-sectional view taken along line 4C-4C of FIG. 4B. FIG. 4D is a side view of the transverse sliding member of FIG. 4A.

FIG. 5A is an isometric view of an exemplary embodiment of a drive screw for the ball valve of FIG. 1A. FIG. 5B is a side view of the drive screw of FIG. 5A.

FIGS. 6A and 6B are respective top and bottom isometric views of an exemplary embodiment of a bottom handle spacer for the ball valve of FIG. 1A. FIGS. 6C and 6D are respective side and top views of the bottom handle spacer.

FIG. 7A is an isometric view of an exemplary embodiment of a top handle spacer for the ball valve of FIG. 1A. FIGS. 7B and 7C are respective side and bottom views of the top handle spacer of FIG. 7A.

FIGS. 8A-8D illustrate alternate embodiments of the transverse slider for a ball valve with flow metering functions.

FIGS. 9A-9B illustrate longitudinal and transverse cross-sectional views of an alternate embodiment of a ball valve with flow metering functions.

FIG. 10 is an isometric view of another alternate embodiment of a flow control valve employing a rotatable element in a conical configuration.

FIGS. 11A-11D are respective side, front and top views of the rotatable element of the valve of FIG. 10.

FIGS. 12A-12B are respective isometric and side views of a valve system with a flow metering function as in any of the embodiments of FIGS. 1-11, but with an actuator system to drive the on/off and flow metering functions of the valve.

### DETAILED DESCRIPTION

In the following detailed description and in the several figures of the drawing, like elements are identified with like reference numerals. The figures are not to scale, and relative feature sizes may be exaggerated for illustrative purposes.

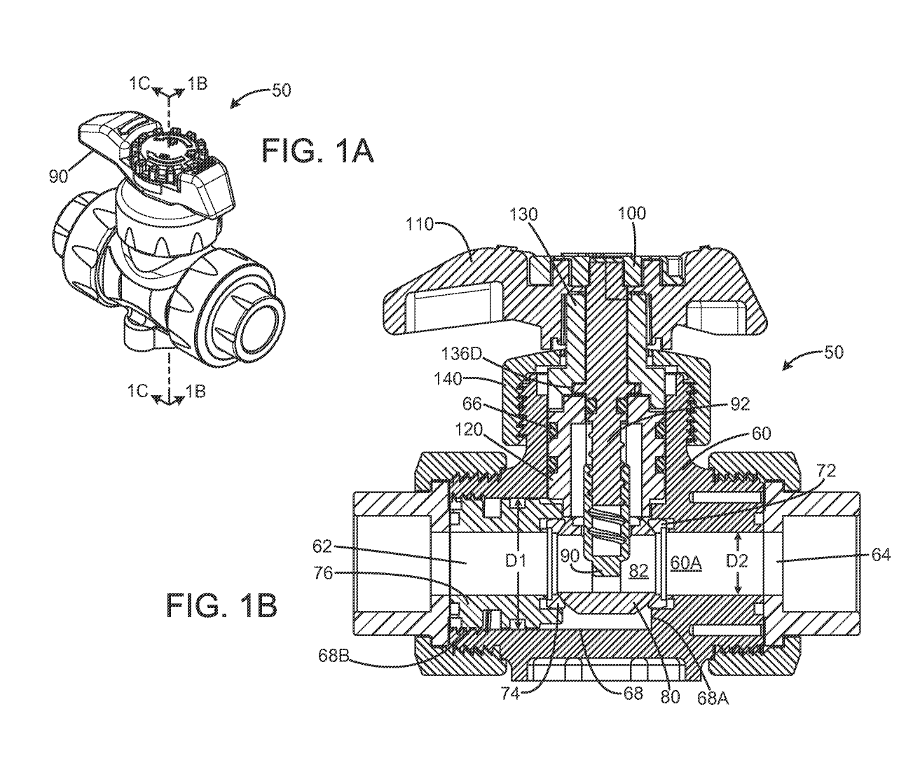

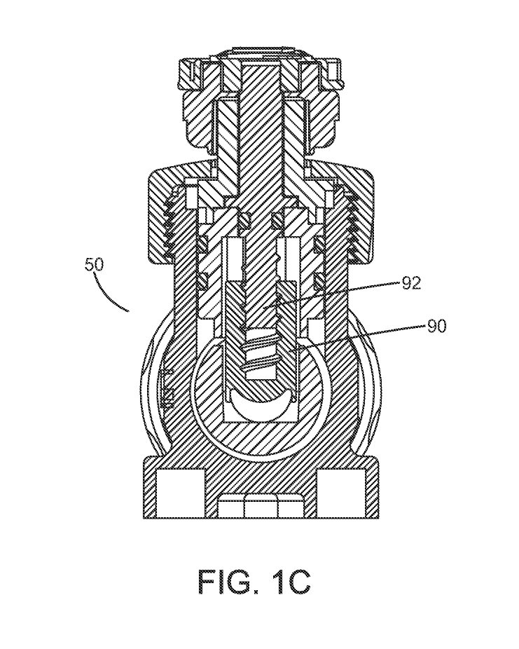

An exemplary embodiment of a flow control valve 50 having a secondary flow metering feature is illustrated in FIGS. 1A, 1B and 1C. The valve includes a rotating component which provides a primary flow control function. The rotating component rotates about an axis, and can be used to open or close the valve, typically with a 90 degree rotation of the rotating component by a handle or actuator 110. The valve includes a secondary flow metering function, by selectively varying the cross-sectional flow passage area through the rotating component. The rotating element may be a spherical ball, a non-spherical ball, or other component configuration which rotates about an axis, such as a conical configuration.

The exemplary embodiment of valve 50 includes a hollow valve body structure 60 with first and second ports 62, 64, with a body flow path 60A extending between the ports. A rotatable flow control component 80, in this embodiment a ball element 80, is positioned in the body flow path intermediate the ports. To allow assembly and disassembly, the body structure 60 has a stepped internal opening diameter, with the interior diameter D1 adjacent port 62 larger than the diameter D2 adjacent port 64. The difference in diameter results in a step shoulder 68A in the inner surface 68 of the body structure, providing a seat for registering the position of the ball element 80. Seals 72 and 74 are installed to fix the position of the ball within the flow path 60A, and allow rotation of the rotatable component 80. A threaded seal carrier 76 engages the internal threads 68B formed on interior surface 68 of the body structure adjacent to the port 62, and is threaded into the body structure to hold the seal 74 in place. The interior diameter of the seal carrier 76 is equal to D2.

In this exemplary embodiment, the body structure is essentially a tee structure with inline ports 62 and 64, and a transverse port 66, through which the control features for the ball valve are introduced into the valve body 60. Each of the ports are provided with external threads to engage mating threaded devices.

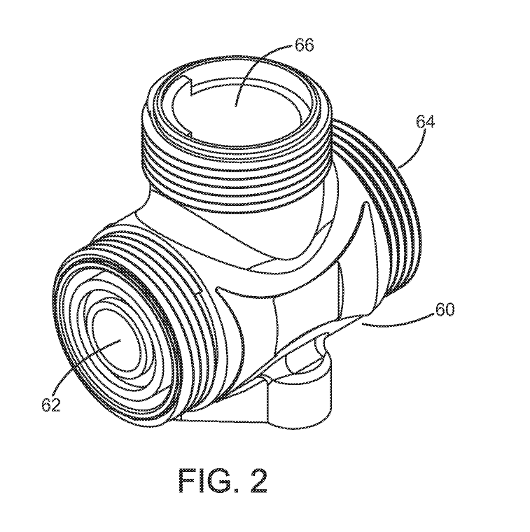

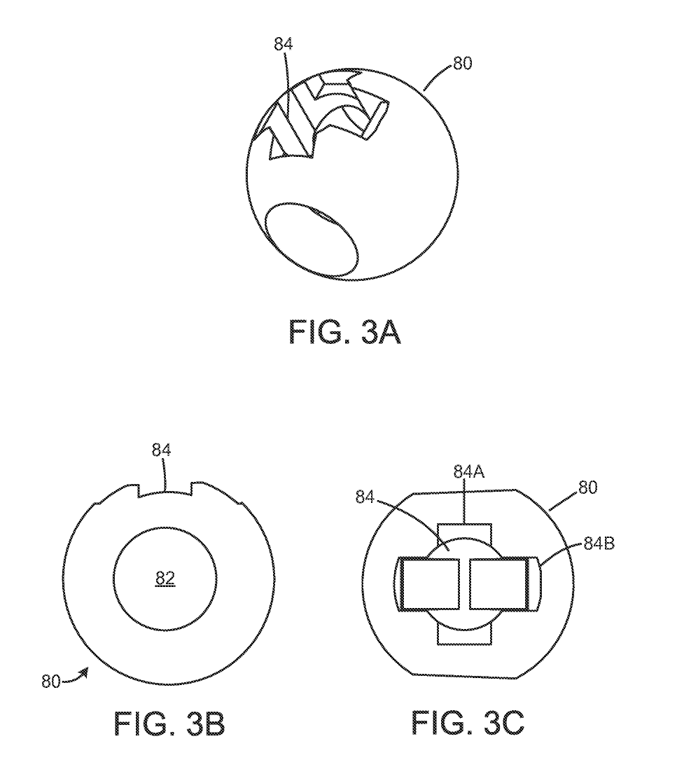

The ball element 80, shown in isolation in FIGS. 3A-3C, is hollow, with flow passageway 82 extending through the ball element. The primary flow control function is provided by rotating the ball element 80 between fully open and fully closed positions, in which the flow passageway 82 is aligned with the flow path through the valve body in the fully open position, and is rotated 90 degrees to position the flow passageway transverse to the flow path, closing the flow through the valve.

Still referring to FIGS. 3A-3C, the top of the ball element facing the port 66 in the body structure has an opening 84 formed through to the flow passageway 82. The opening 84 takes the general form of a cross formed by transverse slot regions, generally shown as 84A and 84B The opening 84B accepts a transverse sliding member, described more fully below, and the distal ends of the slot portion 84A provides surfaces to engage the control feature to turn the ball element.

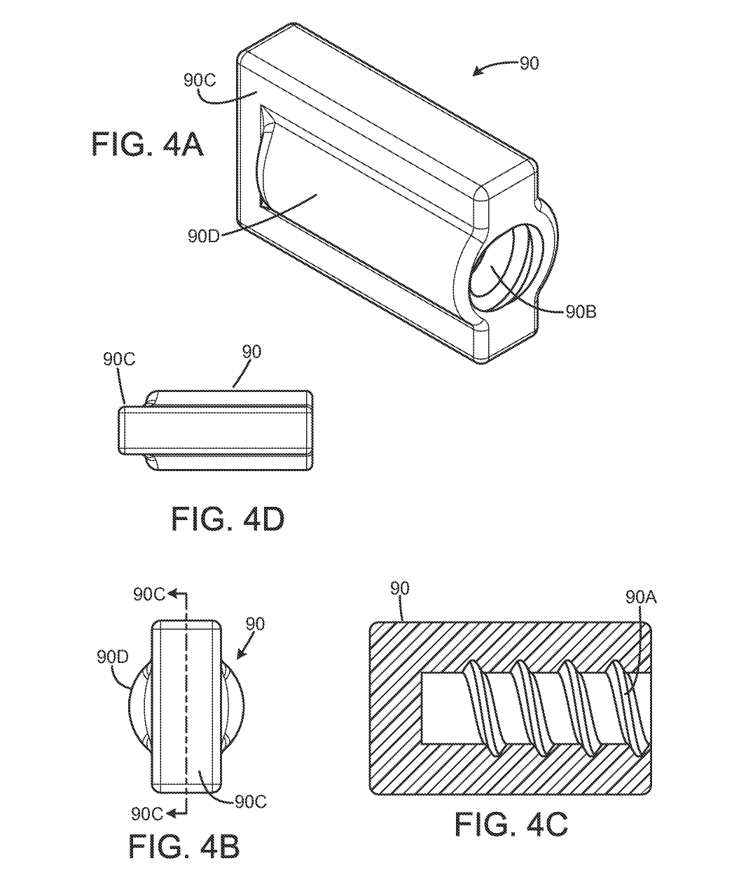

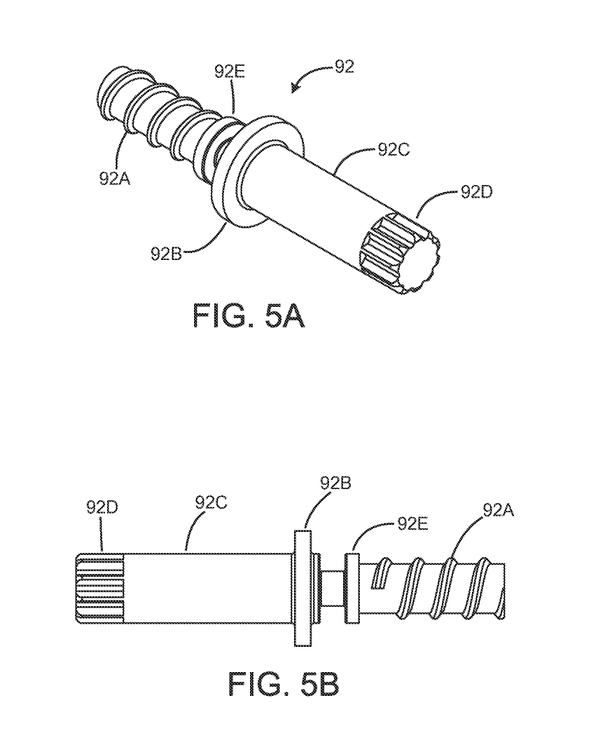

In this exemplary embodiment, the secondary flow metering feature is provided by a transverse sliding member 90 (FIGS. 4A-4D) which can be easily moved into the flow passageway 82 of the ball element 80, thereby increasing or decreasing the effective cross sectional area of flow through the ball element. The sliding member 90 in this embodiment is a hollow member, with internal threads 90A on inner opening 90B. The position of the sliding member is varied through a range of movement by a drive screw 92 (FIGS. 5A-5B), which engages threads 90A in the sliding member 90. The drive screw 92 and the interior threads 90A formed in the transverse member 90 cooperate so that rotational movement of the drive screw is translated into linear movement of the transverse member along its longitudinal axis.

The drive screw 92 is controlled by an adjustment knob 100 located in the center of the valve handle 110. When the adjustment knob 100 is rotated clockwise, the sliding member 90 is driven down and into the flow passageway of 82 the ball element 80 by the drive screw 90. When rotated counter-clockwise, the sliding member 90 is retracted from the flow passageway 82 of the ball element 80. This can be done incrementally for fine flow adjustment.

The drive screw 92 is shown in FIGS. 5A-5B, and includes the external threads 92A on the distal end which engage the internal threads of the sliding element 90; the threads terminate at flange 92E. A second flange 92B separates the upper portion or shaft portion 92C from the threaded portion. An O-ring seal is disposed in the channel or groove formed between the flanges 92B and 92E. The upper end 92D of the drive screw is splined to attach to the adjustment knob 100.

The drive screw 92 and transverse member 90 are configured with the ball element 80 so that, with the transverse member fully withdrawn to its upper limit, the tip 90D of the sliding member is in the slot 84B in the ball element, preferably without any or only a very small portion of the tip within the flow passageway 82. As the drive screw 92 is turned clockwise in this embodiment, the end 90D of the sliding member proceeds further to enter the passageway 82. Further turning of the drive screw will cause the bulge portion 90C of the sliding member (of circular outer cross-sectional configuration) to enter the circular portion of the opening 84 and proceed into the flow passageway.

The valve handle 110 is coupled to the ball element 80 by the lower handle spacer 120 and the upper handle spacer 130, which also support the drive screw 92 for rotation. The upper and lower handle spacers are configured to fit into the transverse port 66 of the valve body structure 60.

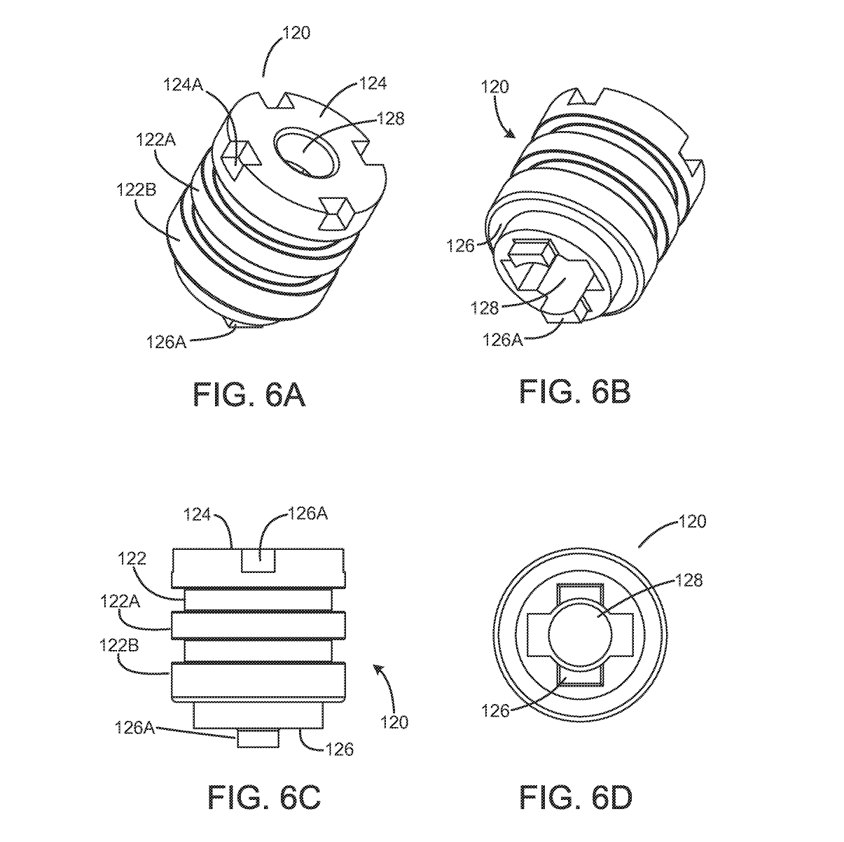

The bottom handle spacer 120 is illustrated in further detail in FIGS. 6A-6D. The spacer 120 has a generally cylindrical configuration, with ribs 122A and 122B extending from the outer periphery of the spacer. O-ring seals are disposed in the channels or grooves formed by the ribs 122A and 122B. The spacer is hollow, with opening 128 formed through its center, and, in a lower portion of the space, is of the same configuration as the outer configuration of the slider member 90 to receive the slider member, as shown in the bottom view of FIG. 6D. This opening configuration serves to constrain the transverse member from rotation, while allowing linear movement of the transverse member 90 along its longitudinal axis. The opening configuration through top surface 124 is circular, as shown in FIG. 6A, allowing the drive screw to protrude therefrom. The bottom surface 126 of the spacer 120 has protruding tab features 126A which are sized to mate with and be captured in the distal slot tips of slot 84A formed in the ball element 80. The tab features 126A allow the handle 110 to control the position of the ball element. The top surface 124 is flat, with recess features 124A sized to mate with corresponding tab features protruding from the upper handle spacer 130.

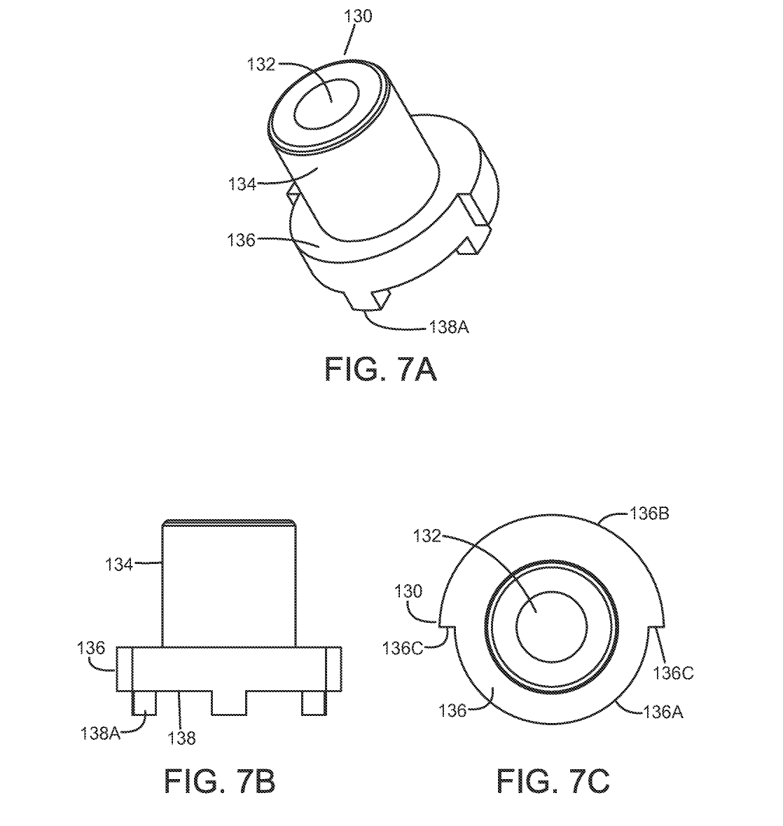

FIGS. 7A-7C illustrate the upper handle spacer 130 in further detail. The spacer 130 has a central opening 132 formed through the spacer, and an upper cylindrical boss portion 134 protruding above a bottom flange portion 136. The cylindrical boss portion 134 is fitted into an opening formed in the bottom of the valve handle 110 in a removable, interference fit. The bottom flange portion 136 has one side 136A of a smaller diameter than the opposite side 136 GB, forming a pair of shoulders 136C which act as stops for open/close rotation of the handle. Four protruding tab features 138A protrude from the bottom of the bottom flange portion, and are configured to mate with the recesses in the top surface of the bottom spacer 120. The bottom flange 136 also has a bottom recess 136D (FIG. 1B) formed in the underside of the flange, and sized to receive the flange 92B of the driver screw 92. The position of the driver screw within the port 66 is constrained by the capturing of the flange 92B between the upper and bottom spacers 130, 120. The handle, connected to the boss portion of the upper spacer 130, can operate to turn the bottom spacer 120, and thereby turn the ball element 80.

A nut 140 has internal threads to engage the outer threads of the transverse port 66 of the body structure 60, to hold in place the assembled upper and bottom handle spacers, the transverse slider member and the drive screw. Leakage through the handle port 66 is prevented by the O-ring seals described above.

The valve handle 100 operates the valve in a conventional manner by turning the ball element 80, ¼ turn on, ¼ turn off. The adjustment knob 100 turns independently of the handle 110 in this exemplary embodiment. The slider rotates with the ball element, thereby remaining in its metering position when the ball element is returned to its open position. Exemplary materials for the parts of the valve include, but not limited to, metals and non-metallic materials such as rigid thermoplastics. Materials used in the construction of the valve may be determined by the application or service of the valve whereby the materials are compatible for the intended environment. Sealing elements are common to the valve industry and include elastomers and PTFE.

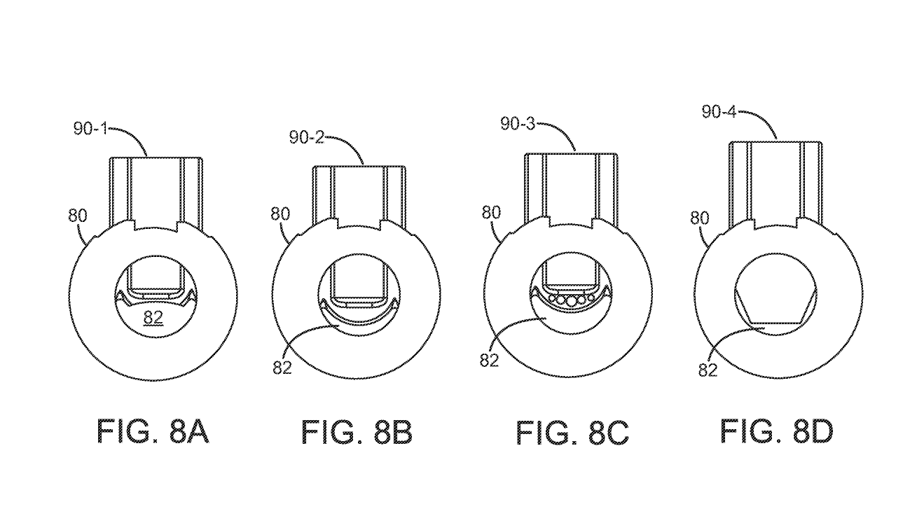

The transverse slider for the valve could take many different forms. Examples of other embodiments of a transverse slider are shown in FIGS. 8A-8D. FIG. 8A illustrates a transverse slider 90-1 in which the distal end has a partial reverse elliptical shape. FIG. 8B shows a transverse slider 90-2 in which the distal end has a tip portion formed on a radius. The transverse slider 90-3 of FIG. 8C is similar to that of FIG. 8B, except that the tip is perforated. FIG. 8D shows a transverse slider 90-4 in configuration in which a flexible, elastomeric “diaphragm” is being stretched into the flow passageway via the driver screw and slider, instead of a flexible tube or rigid slider configuring the flow path geometry. The advantages of alternative embodiments have to do with configuring or characterizing the flow in desired ways. The flow, in a general sense, can be incrementally controlled by the driver/slider mechanism within the primary rotating component.

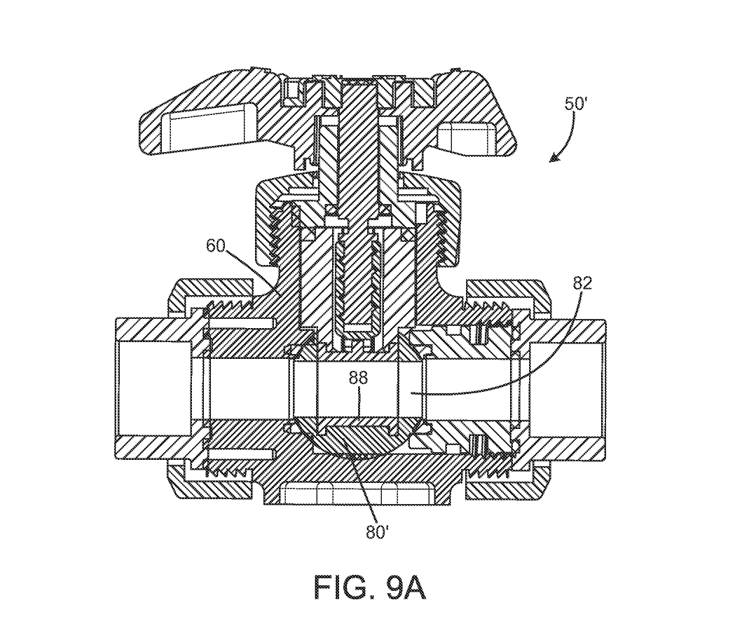

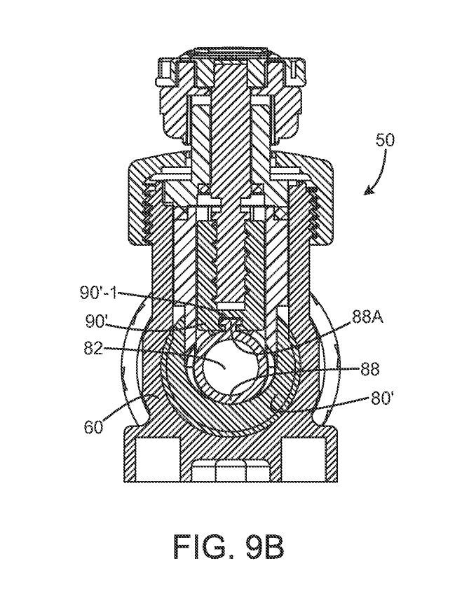

FIGS. 9A-9B illustrate another exemplary embodiment 50′ of a ball valve with a flow metering function. The embodiment 50 of FIGS. 1A-7B employed a transverse slider 90 which entered the flow passageway of the ball element 80 and was directly exposed to fluid flowing through the passageway. The alternate embodiment of FIGS. 9A-9B employs an elastomeric tube or sleeve member 88 which is fitted inside the ball element 80′ to line the passageway 82, and which is contacted by the transverse slide member 90′ as the slide member is advanced into the passageway 82. The slide member 90′ compresses or pinches the sleeve member 88 to reduce the cross-sectional area of the passageway 82. The sleeve member 88 includes a T-shaped tab 88A which fits into a corresponding T-shaped slot 90′-1 formed in the bottom of the transverse slider member 90′ to engage the sleeve member with the slider member, and pull the sleeve member back to a non-compressed position as the slider member is withdrawn. The ball element 80′ may be re-sized relative to the ball element 80 to accommodate the sleeve member so that the inner dimension of the sleeve member is the dimension of the flow passageway through the body structure 60. An elastomeric member, such as the sleeve member or a diaphragm, may be used to change the cross-sectional area of the flow passageway through the rotating element. A sleeve or tube element is cleaner in the sense that the sliding element is not exposed to the flowing media passing through the valve, and keeps the flowing media from wearing on the slider and drive screw. The sleeve can be fabricated of a material that is compatible with the processing parameters of the valve application, and is adequately flexible and resilient to compress and return to a full flow path position. Peristaltic pump tubing may be used, for example.

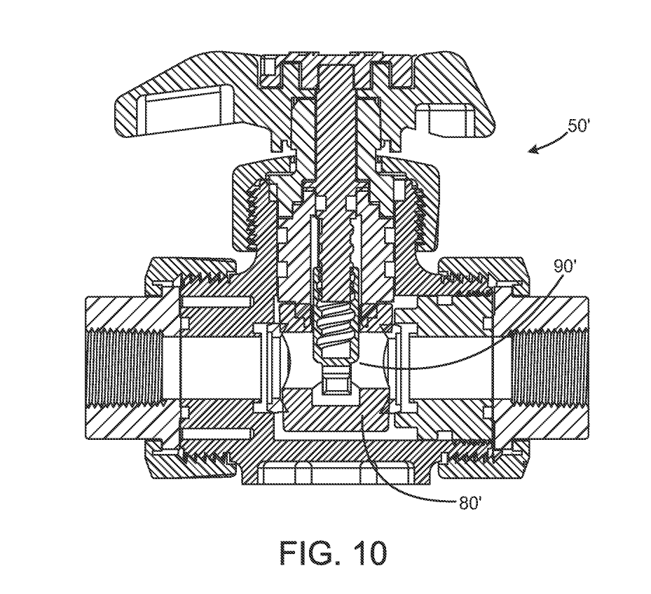

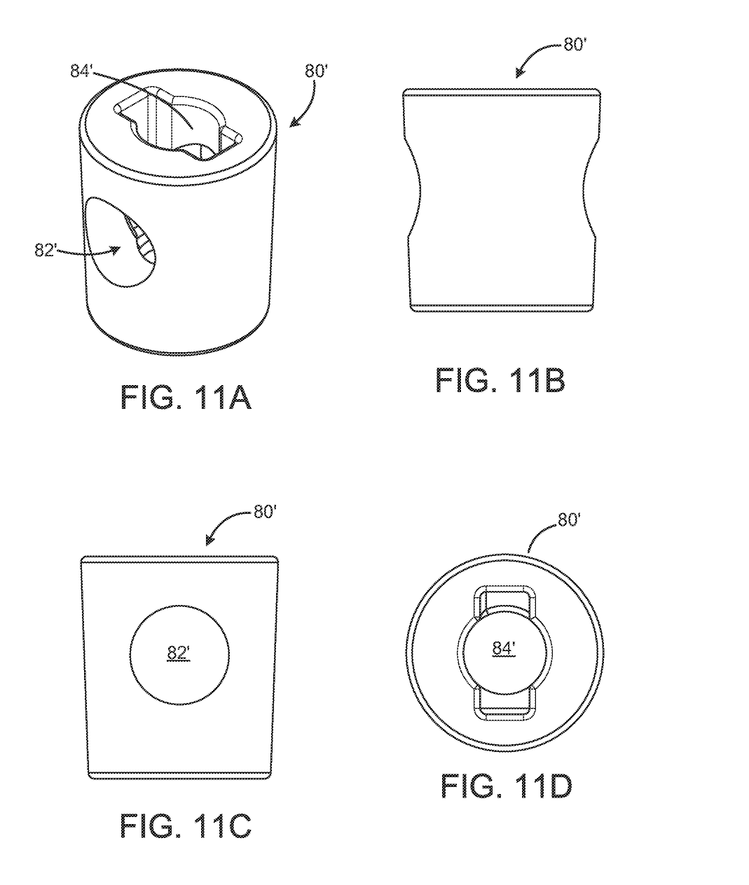

As noted above, the rotating element 80 can take other forms than a ball element, such as a cylindrical or conical configuration. FIGS. 10 and 11A-11D illustrate another exemplary embodiment of a valve 50′ which employs a rotating element 80′ with a conical configuration in which the base width is smaller than the top width. As with the ball element 80 of the embodiment of FIG. 1, the element 80′ includes a flow passageway 82′ and a transverse opening 84′ configured to receive a transverse sliding member 90′ as with the embodiment of FIG. 1.

Features of exemplary embodiments of the valve include one or more of the following.

1. Full flow, full port, full control/metering enhancement to a conventional ball valve with 90 degree (¼ turn) off/on;

2. Infinite flow adjustment, partial ball opening/slider;

3. Set flow, metering. ¼ turn off, return to the same exact flow setting;

4. In contrast to a diaphragm valve with an inherent pressure drop at the full open position, hence a lower Cv(flow coefficient or flow capacity), the valve may have full flow/full port at the full open position.

7. Many possible settings per selected aperture of the full/partial open position of the ball element.

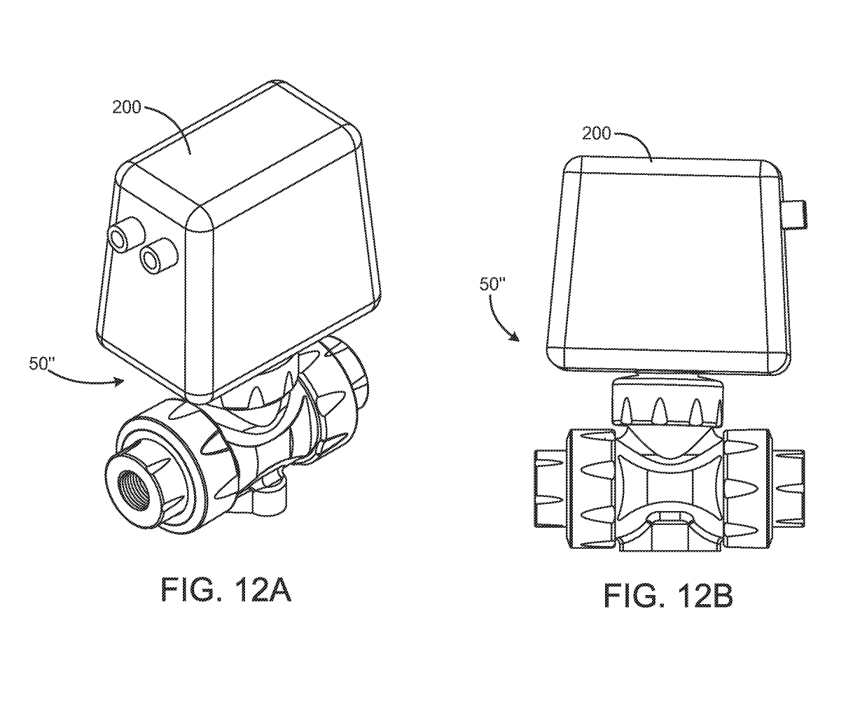

8. When most actuated control valves need to be closed, the actuator motor needs to run perhaps 10 times as long to close as a ¼ turn on/off valve. Exemplary embodiments of the valve may employ an actuator with gearing to drive the ¼ turn off and gearing to drive the metering feature. FIGS. 12A-12B illustrate an exemplary valve structure 50″ employing an actuator system 200 instead of a manual handle and metering knob as is the case with the embodiment of FIG. 1. The actuator system may be an electric motor drive or a pneumatic drive, for example.

Although the foregoing has been a description and illustration of specific embodiments of the subject matter, various modifications and changes thereto can be made by persons skilled in the art without departing from the scope and spirit of the invention.

1. A fluid flow control valve having a primary flow control function and a secondary flow control function, comprising:
a valve body structure comprising a first port, a second port, and a body flow path between the first port and the second port;
a rotatable component having a component flow passageway formed through the rotatable component and supported within the valve body structure for rotation between a valve open position and a valve closed position, wherein in the valve open position the component flow passageway is aligned with the body flow path and in the valve closed position, the component flow passageway is transverse to the body flow path to block the body flow path;
a first mechanism for rotating the rotatable component between the valve open position and the valve closed position to actuate a valve primary flow control function;
a transverse member supported for movement into the rotatable component along a range of movement;
a second mechanism for moving the transverse sliding member to selectively position the transverse sliding member at a desired position within the range of movement, to increase or decrease a cross sectional area of flow through the component flow passageway and provide a selective secondary flow metering function when the rotatable component is not positioned at the valve closed position.

2. The valve of claim 1, wherein:
the first mechanism is configured to rotate the rotatable component about an axis transverse to the valve flow path;
the rotatable component includes a opening extending through a wall of the rotatable component and arranged to allow the transverse member to pass through the opening into the component flow passageway.

3. The valve of claim 1, wherein the first mechanism and the second mechanism are cooperatively arranged such that the rotation of the rotatable component does not affect the relative position of the transverse member within the rotatable components.

4. The valve of claim 1, wherein the second mechanism includes a drive screw which cooperatively interacts with features on the transverse member, whereby rotation of the drive screw in a first direction advances the transverse member in a first direction into the component passageway, and rotation of the drive screw in a second direction retracts the transverse member in a second direction away from the component passageway.

5. The valve of claim 1, further comprising a flexible sleeve member lining the flow passageway of the rotatable component, and wherein the transverse member is configured to apply a compression force to the sleeve member as the sleeve member is advanced to compress the sleeve member decrease the cross section area of flow through the rotatable component.

6. The valve of claim 5, wherein the transverse member has an attachment to the sleeve member to further apply a pulling force to the sleeve member as the transverse member is retracted.

7. The valve of claim 1, wherein the second mechanism comprises a drive screw having a set of external threads on a first portion, the transverse member having an opening formed into a first end with internal threads, and a second end of the transverse member is configured to enter the rotatable component, the first portion of the drive screw and the transverse member configured so that the external threads of the first portion of the screw engage the internal threads of the opening in the transverse member, the transverse member being constrained from rotation, so that rotational movement of the drive screw is translated into linear movement of the transverse member along its longitudinal axis.

8. The valve of claim 7, wherein the second mechanism further includes a rotational feature attached to the drive screw to impact rotational force to the drive screw.

9. The valve of claim 8, wherein the rotational feature is a knob attached to a distal end of the drive screw, the first mechanism includes a handle imparting rotational force to rotate the rotatable component, and the knob and the handle are configured for rotation about a common axis.

10. The valve of claim 7, further comprising:
a bottom spacer member having an opening formed longitudinally through the spacer member and configured to receive the transverse member for movement along a longitudinal axis while constraining the transverse member from rotational motion about the longitudinal axis;
an upper spacer member having a central opening formed longitudinally through the upper spacer member; and
wherein the drive screw has a flange adjacent the threaded portion which is captured between the upper spacer member and the bottom spacer member.

11. The valve of claim 1, wherein the rotatable component comprises a ball element.

12. The valve of claim 1, wherein the rotatable component has a cylindrical or conical configuration.

13. A ball valve having a flow metering feature, comprising:
a valve body structure comprising a first port, a second port, and a body flow path between the first port and the second port;
a ball element having a ball flow passageway formed through the ball element, the ball element supported within the valve body structure for rotation between a valve open position and a valve closed position, wherein in the valve open position the ball flow passageway is aligned with the flow path and in the valve closed position, the ball flow passageway is transverse to the flow path to block the flow path;
a first mechanism for rotating the ball element between the valve open position and the valve closed position;
a transverse member supported for movement into the ball element along a range of movement;
a second mechanism for moving the transverse sliding member to selectively position the transverse sliding member at a desired position within the range of movement, to increase or decrease a cross sectional area of flow through the ball flow passageway and provide a selective flow metering function when the ball valve is not positioned at the valve closed position.

14. The valve of claim 13, wherein:
the first mechanism is configured to rotate the ball element about an axis transverse to the valve flow path;
the ball element includes a opening extending through a wall of the ball element and arranged to allow the transverse member to pass through the opening into the ball flow passageway.

15. The valve of claim 13, wherein the first mechanism and the second mechanism are cooperatively arranged such that the rotation of the ball element does not affect the position of the transverse member along its range of movement.

16. The valve of claim 13, wherein the second mechanism includes a drive screw which cooperatively interacts with features on the transverse member, whereby rotation of the drive screw in a first direction advances the transverse member in a first direction into the ball passageway, and rotation of the drive screw in a second direction retracts the transverse member in a second direction away from the ball passageway.

17. The valve of claim 13, further comprising a flexible sleeve member lining the flow passageway of the ball element, and wherein the transverse member is configured to apply a compression force to the sleeve member as the sleeve member is advanced to compress the sleeve member decrease the cross section area of flow through the ball element.

18. The valve of claim 17, wherein the transverse member has an attachment to the sleeve member to further apply a pulling force to the sleeve member as the transverse member is retracted.

19. The valve of claim 13, wherein the second mechanism comprises a drive screw having a set of external threads on a first portion, the transverse member having an opening formed into a first end with internal threads, and a second end of the transverse member is configured to enter the ball element, the first portion of the drive screw and the transverse member configured so that the external threads of the first portion of the screw engage the internal threads of the opening in the transverse member, the transverse member being constrained from rotation, so that rotational movement of the drive screw is translated into linear movement of the transverse member along its longitudinal axis.

20. The valve of claim 19, wherein the second mechanism further includes a rotational feature attached to the drive screw to impact rotational force to the drive screw.

21. The valve of claim 20, wherein the rotational feature is a knob attached to a distal end of the drive screw, the first mechanism includes a handle imparting rotational force to rotate the ball element, and the knob and the handle are configured for rotation about a common axis.

22. The valve of claim 19, further comprising:
a bottom spacer member having an opening formed longitudinally through the spacer member and configured to receive the transverse member for movement along a longitudinal axis while constraining the transverse member from rotational motion about the longitudinal axis;
an upper spacer member having a central opening formed longitudinally through the upper spacer member; and
wherein the drive screw has a flange adjacent the threaded portion which is captured between the upper spacer member and the bottom spacer member.
